(19) United States
(12) Patent Application Publication
(10) Pub. No.: US 2026/0109034 A1
(43) Pub. Date: Apr. 23, 2026

(54) SYSTEMS AND METHODS FOR PROVIDING SYNTHETIC SPATIAL IMAGINATION

(71) Applicant: NeuMagic, Inc., San Francisco, CA (US)

(72) Inventors: Christoph BIRKHOLD, San Francisco, CA (US); Rolf HERKEN, San Francisco, CA (US)

(21) Appl. No.: 19/359,898

(22) Filed: Oct. 16, 2025

Related U.S. Application Data
(60) Provisional application No. 63/708,958, filed on Oct. 18, 2024.
(60) Provisional application No. 63/789,669, filed on Apr. 16, 2025.

(51) Int. Cl. B25J 9/16

(52) U.S. Cl. CPC B25J 9/1661; B25J 9/1697

(57) ABSTRACT

Methods, systems, devices and computer software/program code products enable the generation of synthetic images based on actual images captured by one or more physical cameras. The generated synthetic images provide visual spatial awareness to enable adaptive behavior in a dynamic environment, including robotics and simulation.

### CROSS-REFERENCE TO RELATED APPLICATIONS

This application claims priority to U.S. Provisional Application No. 63/708,958 filed Oct. 18, 2024, and U.S. Provisional Application No. 63/789,669 filed Apr. 16, 2025, both entitled “Systems and Methods for Providing Synthetic Spatial Imagination,” the entire contents of which are both incorporated herein by reference.

### BACKGROUND OF THE INVENTION

The invention generally relates to automated systems and relates particularly to machine-learning in automated systems.

Spatial information is an important element of automated systems, and many automated applications rely on spatial context information derived from sensor input. There remains a need for automated systems that are able to generate spatial context information and demonstrate spatial awareness and anticipation for many automated applications.

### SUMMARY

In accordance with an aspect of the invention, a method of generating instructions for automated performance of a task is provided that includes continuously acquiring signals representative of observations of at least a portion of one of one or more scenes corresponding to the task, generating a first set of instructions associated with the task while evaluating the acquired signals, using the evaluation to identify a target vantage point of any one of the one or more scenes corresponding to the task, generating signals representative of observations corresponding to the target vantage point, generating a second set of instructions associated with the task while evaluating the signals representative of observations corresponding to the target vantage point, the first set of instructions and the second set of instructions representative of the automated performance of the task.

In accordance with another aspect of the invention, a method of generating instructions for automated performance of a task is provided that includes continuously acquiring signals representative of observations of at least a portion of any one of one or more scenes corresponding to the task, generating a first instruction associated with the task while evaluating the acquired signals, generating and storing an intermediate representation from which signals representative of observations corresponding to a different vantage point of another scene of the one or more scenes can be derived, using the evaluation to identify a target vantage point corresponding to the task, generating signals representative of observations corresponding to the target vantage point using the stored intermediate representation, generating a second instruction associated with the task using the signals representative of observations corresponding to the target vantage point, and performing the task responsive to the first instruction and the second instruction.

In accordance with yet another aspect of the invention, a method of acquiring image signals representative of observations of at least a portion of a scene is provided that includes acquiring image signals representative of observations of the scene, the image signals having a corresponding first vantage point relative to the scene, and generating a spatial image from which an image and a corresponding dense distance estimate can be synthesized, wherein each of the image and the corresponding dense distant estimate are representative of observations of at least a portion of the scene from a second vantage point.

In accordance with still another aspect of the invention, a method of generating instructions for automated performance of a task is provided that includes continuously acquiring image signals to provide acquired image signals representative of observations of at least a portion of one of one or more scenes corresponding to the task, identifying a target vantage point of any one of the one or more scenes corresponding to the task while evaluating the acquired image signals, generating image signals to provide generated image signals representative of observations corresponding to the target vantage point, and generating an instruction representative of the automated performance of the task while evaluating the generated image signals representative of observations corresponding to the target vantage point.

### BRIEF DESCRIPTION OF THE DRAWINGS

These features and aspects of the invention, as well as its advantages, are better understood by reference to the following description, appended claims, and accompanying drawings, in which:

FIG. 1 depicts an illustrative diagram of a system incorporating synthetic spatial imagination for performing automated tasks in general artificial intelligence-based systems.

FIG. 2 depicts an illustrative diagram demonstrating sequential progression of the operation of the system of FIG. 1 to perform an automated task.

FIG. 3 depicts an illustrative diagram demonstrating alternative sources of signals representative of observations.

FIG. 4 depicts an illustrative diagram of a complex object from three perspectives used to demonstrate an aspect of the invention.

FIG. 5 depicts an illustrative diagram of a method according to an aspect of the invention.

FIG. 6 depicts an illustrative diagrammatic view of an object demonstrating the relationship between various perspectives of real and virtual cameras according to an aspect of the present invention.

FIGS. 7A-7D show illustrative diagrams of methods for generating tasks without spatial attention (FIG. 7A), separately trained with spatial attention (FIG. 7B), separately trained with spatial attention using a neural solver (FIG. 7C), and fully integrated with the task (FIG. 7D).

FIG. 8 depicts an illustrative diagram of a method for implementing a neural solver according to an aspect of the present invention.

FIG. 9 depicts an illustrative diagram of a combination of environments and scenes corresponding to the task according to an aspect of the present invention.

The drawings are shown for illustrative purposes only.

### DETAILED DESCRIPTION OF THE INVENTION

Systems and methods and computer program code products (e.g., software) for Spatial Video that generate synthetic images of a scene or objects based on actual images captured by one or more physical cameras having a view of a scene have led to the development of Synthetic Spatial Imagination (SSI). This new and novel SSI is intended to address fundamental challenges resulting from deficiencies in spatial attention in current Generative Visual Artificial Intelligence (AI)-based systems and in Generative Physical AI-based robotics.

SSI is critical for the spatially and temporally coherent and congruent generation of traditional video, Spatial Video, and spatial worlds. With traditional video, while spatial information is not directly encoded in the generated material, the generation process depends on spatial context for any part that depicts a three-dimensional scene or object-just like an artist might use vanishing points as an aid to create a coherent depiction of a scene on paper. Spatial Video generation further requires congruent synthesis of several views of the same scene as observed at the same time, which depends on a spatial understanding of the scene. Generating spatial worlds, either in the form of spatial data structures to be interpreted by a simulation/rendering engine or generated continuously as video based on a scene description, prior frames and user input, also requires spatial context and anticipation to result in spatially and temporally coherent and congruent reproduction of a scene. Learning these spatial skills in the training process is enabled by Spatial Video technology.

Importantly, SSI can also generate spatial awareness and anticipation. Thereby SSI will advance the field of Generative Physical AI based robotics and enable the development of advanced robotics applications. For instance, in scenarios that require interaction with malleable objects, the unique deformation of each object under manipulation cannot be fully predicted from an initial observation alone yet is highly consequential to a successful outcome. Having spatial awareness not only during the offline training process but also as a real-time skill in the physical embodiment of the process is a crucial advantage.

Given that any goal directed or exploratory adaptive behavior in a dynamic environment requires spatial imagination-based awareness and anticipation, SSI is expected to emerge as a necessary component of Artificial General Intelligence and General Robotics.

Generally, disclosed herein include Task Generation Based on Spatial Attention, Task Generation Based on Spatial Signals, as well as Neural Solver and Neural Spatial Image. In-Network View Generation is a form of virtual sensor signal synthesis from a Spatial Image, Neural Spatial Image, Spatial Video or Neural Spatial Video. Task Generation Based on Spatial Attention requires Spatial Attention Policy and is the application for In-Network View Generation. Task Generation Based on Spatial Signals is also an application of In-Network View Generation. Thus, all four of Task Generation Based on Spatial Attention, Task Generation Based on Spatial Signals, Spatial Attention Policy, and In-Network View Generation can be considered as one family.

Neural Solver and Neural Spatial Image is another family that builds and improves upon known methods and systems for determining correspondence between features of an image or signal and a search domain in a second image or signal and systems and methods for reconstruction of synthetic images of a scene from the perspective of a virtual camera. Additionally, initializing gaussian splats from a point cloud derived from augmented synthesized images offers an efficient way to bridge the methods described here with machine learning method relying on such a representation. These, and other methods and systems are further described herein below.

### Task Generation Based on Spatial Attention

The following describes a method for a computationally efficient training and execution of a system that generates instructions for automated performance of tasks including challenging tasks such as goal directed and exploratory adaptive behavior in complex real-world environments. Instructions may for example be a time sequence of transforms for a robotic arm, kinematic goals for end effectors or other formal instructions interpretable by the automatism. Adaptive behavior is for instance required when interacting with malleable materials, complex multi-material or organic objects for which the composition is not well known or adapting to dynamic changes in the scene.

Essentially all tasks for which not all steps can be planned based on information available at the start of the task alone fall into this category. In contrast, CNC machining for instance relies on known material properties and a static environment and can thus operate on pre-programmed instructions to produce results in predictable and acceptable tolerances.

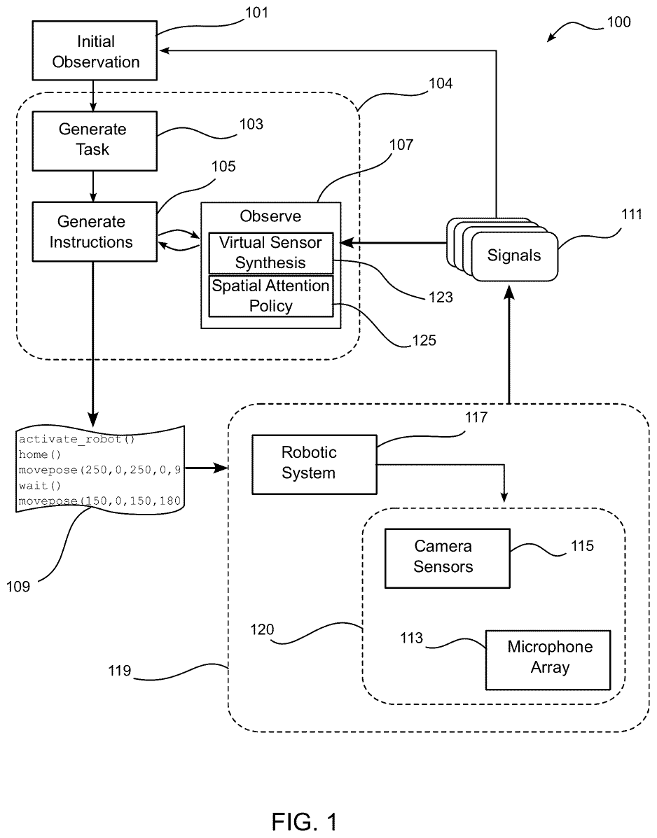

There is no fundamental reason why machines should perceive with a limited number of physical sensors places at fixed vantage points. Practical limitations inherent in using physical sensors are effectively removed by virtualizing sensors and performing signal synthesis. For instance, when using image sensors, synthesizing multiple novel views at multiple vantage points. FIG. 1 shows an overall architecture of the system 100 according to an aspect of the invention. Methods, systems, devices, and computer software/program code products in accordance with the invention are suitable for implementation or execution in, or in conjunction with, commercially available computer graphics processor configurations and systems including one or more display screens for displaying images, cameras for capturing images, and graphics processors for rendering images for storage or for display, such as on a display screen, and for processing data values for pixels in an image representation. The cameras, graphics processors and display screens can be of a form provided in commercially available smartphones, tablets and other mobile telecommunications devices, as well as in commercially available laptop, desktop and industrial computers or combinations of the same connected thereto, which may communicate using commercially available network architectures including client/server and client/network/cloud architectures.

In the aspects of the invention described below and hereinafter, the algorithmic image processing methods described are executed by digital processors, which can include graphics processor units, including GPGPUs such as those commercially available on cellphones, smartphones, tablets and other commercially available telecommunications and computing devices, as well as in digital display devices and digital cameras. Those skilled in the art to which this invention pertains will understand the structure and operation of digital processors, GPGPUs and similar digital graphics processor units.

Referring still at FIG. 1, signals 111 are provided by sensors 120 embedded in scene 119 such as a grid of camera sensors 115 or a spherical microphone array 113 that provide scene observations including initial observation 101 and operational observations 107. Initial observations 101 are used to generate the task at 103 using digital processor 104 and generate instructions 105. Continued observations 107 of the scene 119 are used to continue generating instructions 109 to proceed with the task. The observe function 107 may include the use of Spatial Attention Policy 123 and/or Virtual Sensor Synthesis 125. The instructions 109 are provided to perform the desired task. Instructions can be for a programmable motion device, such as robotic system 117 that generates motion in the performance of the task. Instructions 109 can be associated with any type of automated task including parameters controlling a process, directions for navigation, or workflow automation. Instructions can include training for a task to be automatically performed. Instructions may further include immediate values generated along with the instructions or make references to external values. The set of instructions can also be empty if no actions must be performed at that iteration to progress with the task. Signals 111 are generated from the sensors 120 to provide operational observations 107. Signals 111 can be provided by sensors 120 directly in real time, or indirectly, such as from storage.

In contrast to conventional approaches, which rely on relevant but ultimately constrained and unfocused sensor data in the training as well as for the initialization and supervision of a specific task, The method of system 100 uses Spatial Attention 123 as part of the operational observations 107 to determine the actual required observations from some or all of the best vantage points. Additionally, the method of system 100 includes virtual sensor synthesis 125 as a part of the observation 107, as described further herein below including, the generation of synthetic signals of a scene or objects based on actual signals captured by one or more physical sensors having samples of a scene.

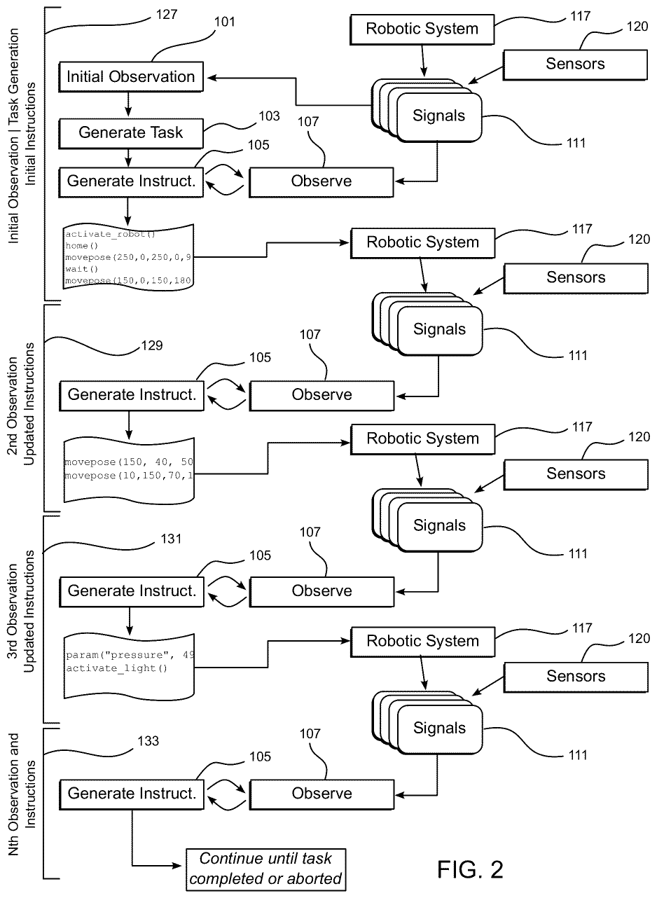

FIG. 2 depicts the sequential progression of the operation of the system 100 in the performance of an automated task. As a first step 127 the system 100 generates a task at 103 and using Generate Instructions 105 generates initial instructions 109 from an initial observation 101 of signals 111. At a second step 129 the signals 111 are evaluated by Observe 107 in the context of the state of the task to provide Generate Instructions 105 with the signals required to generate the next instructions 109 in the performance of the task. Observe 107 may be evaluating signals 111 by a spatial attention policy 123 to identify a target vantage point of the scene corresponding to the state of the task and perform virtual view synthesis 125 to generate signals for Generate Instructions 105. Instructions 109 generated by Generate Instructions 105 are executed before continuing further to a third step 131, where the signals 111 are again evaluated by Observe 107 and Generate Instructions 105 generates the next instructions 109 in the performance of the task. Observe 107 may identify yet another target vantage point of the scene corresponding to the task and provide synthesized signals to Generate Instructions 105. Again, at the nth step 133, where the process continues until the task is completed or the sequence is aborted. The signals generated by Virtual Sensor Synthesis 125 in each of the iterative steps of the process shown at FIG. 2 are each representative of the observations corresponding to the target vantage point of the scene and the generated instructions 109 cumulatively represent the automated performance of the task.

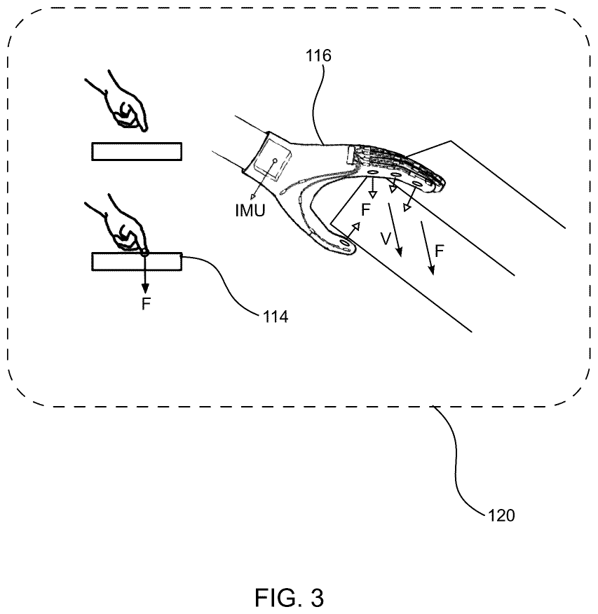

FIG. 3 shows signals 111 can be provided by additional sensors 120 providing any of velocity, acceleration, force, contact information, physical properties of objects in the scene, sound, temperature, altitude, chemical environment, infrared, radiation, and others as signals 111 to the system 100 exemplary of recording interactions of a human or robot with the scene. Such signals may for instance be recorded from haptic sensors or exoskeletons 116 worn by a human or a robot. Such signals 111 may also be derived from sensors that are part of a mechanism or derived from actuators in the mechanism. Simultaneous and synchronized recording of these signals with visual observations, or other observations of the scene from which a location can be derived, of a scene allows the signals to be implicitly or explicitly spatially localized in a scene where such information is not directly available from the signals. The localized signals are then used in the training and exploitation of a Spatial Attention Policy 123 and evaluated in the generation of instructions. The signals also support the training and exploitation of a task policy to perform an automated task. For instance, when the task is learned from human demonstration 114, additional signals from a worn haptic sensor glove 116 enrich scene understanding when working with malleable objects.

According to aspects of the invention, the signals 111 as well as the signals generated by virtual sensor synthesis 125 and signal representative of observations corresponding to a target vantage point can be stored for later retrieval, such as when a signal is acquired or generated as described above, in the performance of a task. Signals may also be captured and stored for later retrieval when recording a demonstration of a task. The signals can be retrieved from storage for re-use such as to generate a duplicate or alternative set of instructions, to evaluate the performance in the task, as training data for task or to extend observations of a scene with signals from another scene. The signals 111 stored and identified for re-use can be associated with the performance of a task in a real environment, or the signals 111 stored and identified for re-use can be associated with a task in a virtual environment. As described below in further detail, when signals are stored and retrieved for later reference, the signals can be representative of observations of a separate scene or a different respective vantage point of a scene.

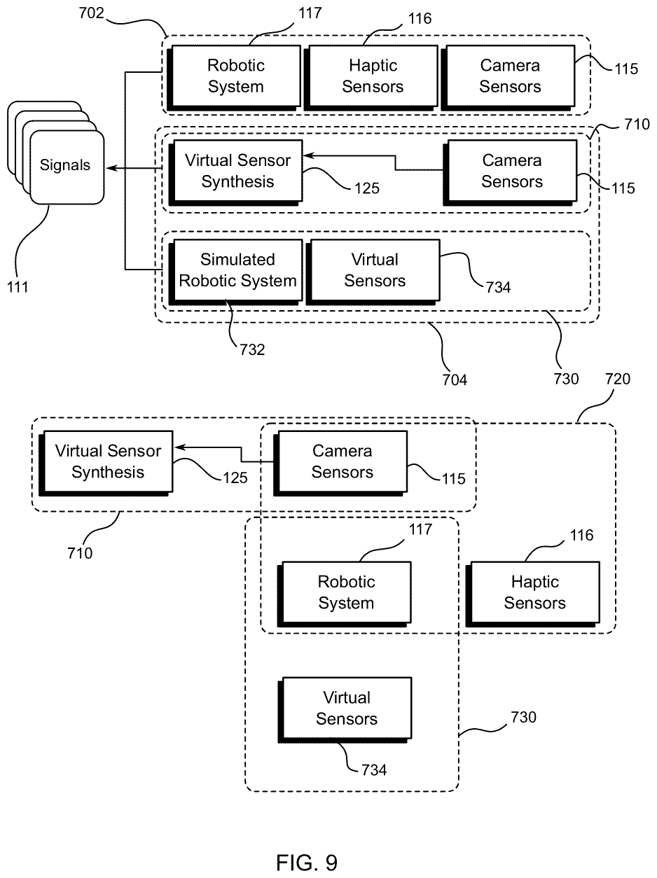

FIG. 9 shows an example of how multiple environments and scenes within each environment can be combined to provide a shared context for the task in the form of a hybrid environment. Here the total set of scenes in the example configuration 700 comprises two environments, one real environment 702 and one virtual environment 704. The real environment 702 further comprises one virtual scene 720 containing a robotic system 117, a physical camera sensor 115 and a human actor wearing a haptic sensor glove 116. The virtual environment 704 further comprises two scenes with the first virtual scene 710 containing a virtual sensor, the signal of which is generated by performing virtual sensor synthesis 125 from signals acquired from the physical camera sensor 115 and the second virtual scene 730 contains a simulated version 732 of the robotic system 117 as well as additional virtual sensors 734. The real and virtual sensors in the scenes acquire signals 111. Additionally, some of the virtual sensors can be used to generate signals representative of observations corresponding to target vantage points identified by a spatial attention policy 123. The actual combination of environments and scenes varies by task and can be highly flexible as long as a coordinate system transform exists that converts between poses in the scenes. An important aspect enabling this flexibility is the use of virtual sensor synthesis from physical sensor signals which effectively allows virtual sensors to be placed in real scenes. A scene can be a proxy or surrogate for another scene, provide an extension of another scene or an approximation for at least part of another scene. This enables training and exploitation scenarios, including where the sensor signals recorded in a virtual simulation or recorded from a real-world demonstration are streamed from storage in performance of the scenario. When training of a task must at least in part be performed in a real environment it is desirable to limit the scope of that environment for practicality of training at scale. Verifying performance of the task in different environments is another example of using a hybrid environment. Being able to transparently extend the real scene with a virtual scene thus has great benefits. A virtual scene extension may range from a simple panoramic image to a whole spatial world generated using generative AI form a textual description or extrapolation from a single image and then simulated, to generating a complete explorable space “out of core” on a frame-by-frame basis using the previous frames and a set of actions as input. In scenarios where a certain process cannot be simulated in a virtual training environment with sufficient fidelity, being able to use a hybrid environment with a part of the scene in a real environment or playing back recorded signals captured from a real environment, has applications in virtual training. When observing the internal process of a real object is important in the performance of the task in the real environment but none of the available physical sensors are able to observe the process the process can instead be simulating in a virtual scene that approximates the relevant parts of the real scene and observations of the process can be observed using a virtual sensor in the virtual environment. A proxy can replicate task-relevant aspects but provide additional signals not available from the delegate scene. An example is using a surrogate of a physical system in a virtual scene enables generating, and evaluating the future consequences of, multiple candidate instruction sets associated with the performance of the task before determining the final instruction set executed in the real environment. Here a virtual environment enables prediction of the future state of the real environment by means of simulation taking advantage of accelerating time, reverting to a previous state of the simulation, etc. For training purposes flexible and scalable virtual scenes that are approximations of real scenes can be used where the required skills are transferrable to the embodied application. For instance, training a Spatial Attention Policy 123 that determines a target vantage point for virtual sensor that generates signals by Virtual Sensor Synthesis 125 from physical sensor signals is possible in a virtual environment in many cases in this way. Furthermore, a virtual sensor can provide signals representative of synthesized observations from a separate scene in a real environment to allow exploitation or training in virtual environments to stream in certain real-world observations, such as through retrieving stored signals representative of observations of separate scenes.

Referring still at FIG. 9, in the example configuration 700 signals acquired from the physical camera sensor 115, the haptic sensor glove 116 and signals provided by the physical robotic system, such as from its motion encoders and force sensors, can be used by a Spatial Attention Policy 123 to determine a vantage point for observations which are then generated by Virtual Sensor Synthesis 125 from signals acquired by the physical camera sensor 115 and further vantage points for observations which are then generated from virtual camera sensor 734 by a rendering method from the virtual scene 730 which includes the simulated robotic system 732. The generated signals together with additional information generated by simulation of the robotic system 732 are then used by Generate Instructions 105 to determine the next steps in the automated performance of the task.

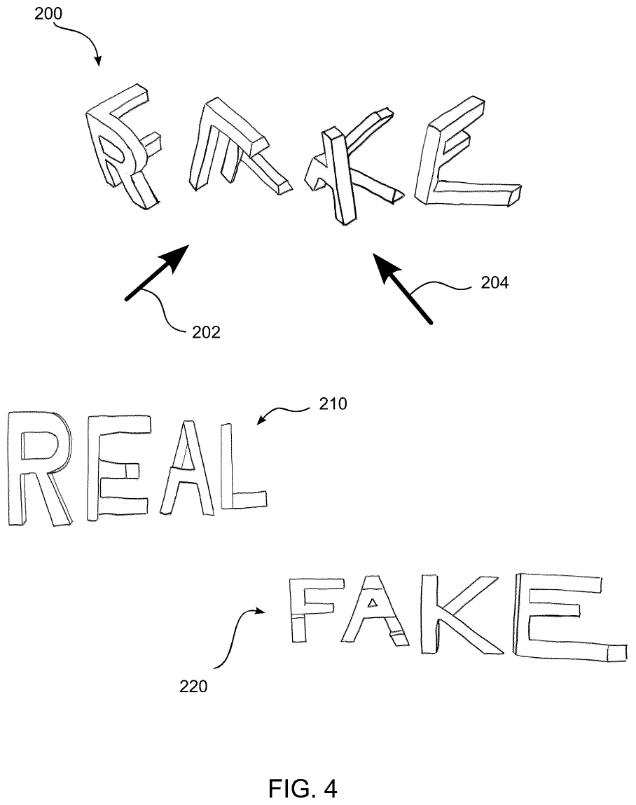

FIG. 4 shows the importance of spatial imagination in an illustrative example of a complex structure. In a first perspective 200, the complex structure is shown as four items arranged sequentially. When viewed from the direction shown by arrow 202, the second perspective 210 shows the four items arranged sequentially to spell the word “REAL.” When viewed from the direction shown by arrow 204, the third perspective 220 shows the four items arranged sequentially to spell the word “FAKE.”: Three perspectives on one and the same object each yield very different results. As a practical application, consider a robot operating with a single camera providing a single vantage point on the complex structure shown in FIG. 4. From the second perspective 210 the “R” is clearly identifiable as such by the robot. From the first perspective 200, the vantage point, perhaps augmented with a dense distance estimate, the robot may be able to identify the “R” but from the third perspective 220, the “R” is no longer identifiable. The addition of lighting makes the appearance of the structure even more complex. An agent without spatial imagination may now see a shadow of an “R” for the object identified as “F”.

The method of system 100 applies a Spatial Attention Policy 123, performing the function of evaluating a vantage point as well as supporting the evaluation of the number and types of virtual sensors, that is combined with a method for Virtual Sensor Synthesis 125 from signals 111, the latter generating signals representative of the vantage points. Virtual sensor signals in a real environment can be synthesized from real sensor signals using a suitable method for the type of signals such as the methods for image view synthesis referenced and described below. Virtual sensor signals in a virtual environment can often be evaluated directly by such means as sampling or rendering. Virtual sensors signals can also be synthesized from a separate set of virtual sensors in a virtual environment. Thus, virtual sensors can also be used in a hybrid environment where the automated task is partially executed in a real environment and partially executed in a virtual environment.

One illustrative implementation of such a combination is to evaluate signals 111 to identify a target vantage point of the scene corresponding to the task associated with the instructions in a way that can be guided by exploring candidate instructions representative of the automated performance of the task. The iterative process described above can explore more than one path to arrive at instructions for the performance of the task and a virtual environment can be established to execute the instructions representative of the automated performance of the task to evaluate the candidate instructions and determine the final vantage point and instruction for the performance of the task in the target environment at the next step.

An illustrative implementation of a virtual sensor synthesis 125 method for image views is to use a multi-axis stereo-search over the input images to establish a disparity map for each image (effectively, ‘solving’ the scene) then using the disparity information along with the source images to reconstruct a novel view of the same scene. Examples include those described in U.S. Pat. No. 11,550,387 entitled Stereo Correspondence Search, and U.S. Pat. No. 11,189,043 entitled Image Reconstruction for Virtual 3D, each of which is incorporated herein by reference.

Another such method of applying the Spatial Attention Policy 123 is to select from real world observations from a set of physical sensors that provide signals representative of observations of a scene in a real environment or virtual sensor signals from a scene in a real or virtual environment. Where a sensor is virtual the Spatial Attention Policy 123 can also determine the respective vantage point and other parameters of the sensor.

One application of the combination of the Spatial Attention Policy 123 with synthesized sensor views 125 is used to generate a task specific, optimized, set of camera parameters, that is free from the constraints inherent in placing physical cameras in a scene as well as the constraints inherent in real-world sensor designs. This method is not limited to training or execution in a purely virtual environment, where sensors can more easily be virtualized, and can scale a small set of real recordings to nearly arbitrary Spatial Attention Policy iterations in the training environment, all while having identical capabilities at inference time in the real world.

As disclosed above, the signals representative of observations may include image data, and such image data can be generated by a rendering engine form a virtual scene or image view synthesis from a real scene, or images from a physical sensor. The image data can comprise a plurality of resolutions, and an image map can be provided indicating a quality of each pixel to be factored when generating instructions therefrom. Accordingly, the method where the signals 111 are evaluated to identify a target vantage point of the scene corresponding to the task associated with the instructions, the signals 111 can be derived from any one or combination of physical and virtual sensors as source images. Additionally, the source image can be derived or rendered by a rendering engine from a virtual scene. Alternatively, the source image can be acquired from one of a set of physical or virtual sensors, each one of the set of sensors providing images representative of observations corresponding to a different respective vantage point of a scene corresponding to the task. Any one or more of the physical or virtual sensor can be associated with a different scene as described above.

This method results in dramatic efficiency gains in especially in the training but also the execution of tasks. In training, effective domain randomization is now possible with real-world data. Domain randomization in training improves robustness of agents against variations in the task and environment. It is also known to improve Domain Generalization (out-of-distribution) capabilities. Robustness and generalization in the presence of spatial changes is important for agents with physical agency. The value of each real-world recording is multiplied by being able to exploit it from numerous perspectives, especially when each session is difficult or time-consuming to record, such as with human demonstrations.

In one aspect, a task performed in a virtual world can be performed as a demonstration for an automated performance of the task. Generated instructions derived from observations based on signals 111 can arise from evaluation of stored signals, such as those recorded in human demonstrations. Tasks then performed in the virtual world, or a subsequent task in the real world, benefit from the recorded and stored instructions that can be exploited from such perspectives.

Together, this makes it feasible to perform a new set of tasks automatically for the first time. The method can be thought of as giving the automated system Visuospatial Skills resulting from Synthetic Spatial Imagination, i.e., trained visuospatial skills in an Artificial Neural Network (ANN), and thereby expanding its capabilities.

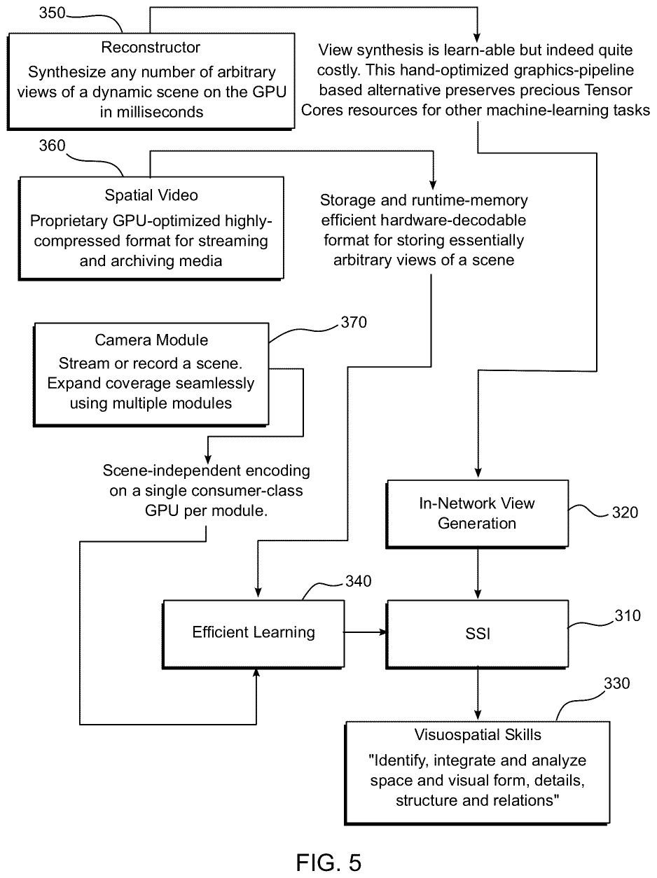

Referring now to FIG. 5, an illustrative aspect of the method 300 for enabling technologies for Synthetic Spatial Imagination (SSI) 310 are shown that are included as an element of the observe function 107 of FIG. 1. In-network view generation 320 is derived from synthesized 125 and reconstructed arbitrary views of a dynamic scene using the Reconstructor 350 from signals 111. The GPU of the system 100 can synthesize any number of arbitrary views of varying resolution of a dynamic scene while tensor cores of the GPU, including those that enable mixed precision computing, dynamically adapting calculations to accelerate throughput while preserving accuracy and security, are reserved for specific mathematical operations and other machine learning tasks. Meanwhile, spatial video 360 is acquired and stored (or cached) in an optimized highly-compressed format for streaming and archiving media. Compression algorithms can be selected for efficient hardware-decodable format for storing essentially arbitrary views of a scene. One or more camera modules 370 are provided to stream or record a scene. Intrinsic calibration of each camera in the camera modules 370 and extrinsic calibration between at least pairs of cameras in each module provides important meta data for generating spatial video 360, image synthesis by the reconstructor 350 as well as the vantage point of a view captured by a camera in a module within a scene more generally. The modular structure of the camera modules 370 provides seamless expansion of coverage by adding additional modules 370. The extrinsic calibration of each camera module 370 provides the basis for dynamically establishing the relationship of multiple modules in a scene. The camera modules 370 provide scene-independent encoding of image data using a GPU resources associated within each module.

The task of camera module design, including the arrangement of camera sensors in the module, and their placement in a scene, for a particular scenario, can itself be accomplished from an initial generic design using the methods described herein.

Accordingly, the spatial video 360 and the scene-independent representation from the camera modules 370 provide input for efficient learning 340 of tasks, as described herein below. The efficient learning 340 together with the in-network view generation 320 are the essential elements to SSI 310 that provides a machine with a set of visuospatial skills 330 to identify, integrate and analyze space and visual form, details, structure and relations.

While it is possible to use method 300 with physical cameras directly-using actuators to move one or more cameras or selecting from a large set of physical cameras this obviously does not scale well to do machine learning nor is it economical on a real-world application. However, there are limited applications, such as in verification of the methods described herein with ground-truth sensor, were the option of working with configurable physical sensors is useful.

Method 300 can be understood to emulate an artist continuously adjusting their point of view to see their work from just the right angle to perform the next step, a surgeon repositioning an imaging device to always get the right perspective or airport security looking at x-ray scans from multiple angles to be able to separate a knife from a model airplane—in these cases the human mind provides the required spatial imagination and visuospatial skills. This method has, going beyond these examples, in a super-human fashion, all the relevant views available simultaneously.

At the limit, by using a dynamic set comprised of a very large number—limited only by available compute and memory resources—of virtual sensors distributed throughout the scene and sampling a the rate/resolution/etc. decided by the attention policy to be suitable to the task at the time, essentially all relevant information from the entire light-field, audio-field or other type of information propagating through the scene can be made available. For instance, instead of one camera sampling 100×100 pixels from a single vantage point at a single rate, 2500 virtual cameras could, from as many unique vantage points, each sample a small number of relevant pixels at variable rate. Both, amortized over time, resulting in the same quantity of data but the latter approach representing a multitude of vantage points.

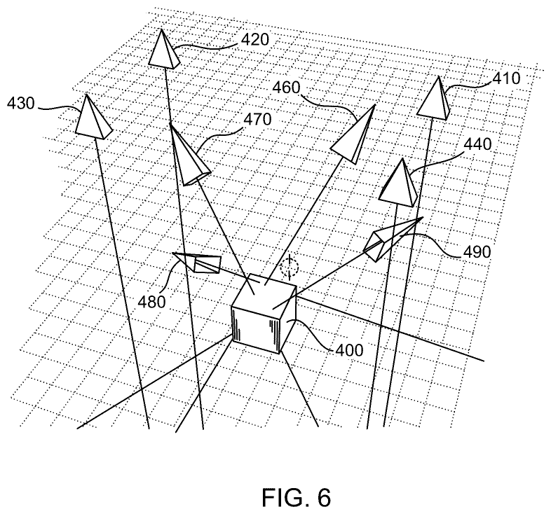

FIG. 6 shows an illustrative example of the input to a camera module 370 and a set of virtual cameras synthesized by reconstructor 350 from those real cameras in the scene. For clarity, the real cameras are typically part of a modular camera assembly where the module acquires the images and performs the solving part on a GPU. The resulting spatial image and/or spatial video include some of the real camera images passed to the reconstructor for producing virtual sensor images. Real camera A 410, real camera B 420, real camera C 430 and real camera D 440 together form one possible camera module 370 and each provide image data representative of at least one perspective of object 400. From the image representations of object 400 from at least one of real cameras 410-440, at least one of a first virtual camera 460, a second virtual camera 470, a third virtual camera 480 and a fourth virtual camera 490 can be derived. For clarity, a very small set of virtual sensors is depicted.

Virtual sensors are optionally synthesized in-network within an ANN for efficiency. The inputs and outputs of the sensor synthesis are inter-operable with the artificial neurons in the ANN and in some-cases can execute concurrently and in parallel to other parts of the ANN.

The Spatial Attention Policy 123 can be trained along with the task or separately. In the simplest case an attention policy is run as an input generator for a pre-existing task. When trained separately like this the goal is to optimize the performance of the pre-existing task, according to its evaluation function, by focusing its attention on the most relevant parts of the scene. In essence, the Spatial Attention Policy learns how to best help the task to succeed by facilitating spatial attention on its behalf. The degree of optimization achievable is related to both the degree of deficiency the task has with respect to spatial attention as well as the degree of possible cooperation between the two policies. In this scenario the number of sensors and their basic parameters are also limited by the original task definition. If deeper access to a pre-existing task is available additional (latent) information from the task can be used to improve outcomes and/or learn more effectively. Similarly, if the task accepts sensor configurations this creates additional dimensions the attention policy can exploit. Available (latent) information from the Task is combined with current observations of the scene to determine the best next set of (virtual) sensor parameters and the synthesis of their signals, or synthetic signals.

When working from a clean slate the task and Attention Policy can be trained together, again using the task's original evaluation function or a slightly augmented version thereof, but in this case reducing duplications of functionality and allowing the latent encoding to be shared more effectively. When trained in combination with the task, the task also benefits from auxiliary and (latent) information produced by the Attention Policy as part of its operation. The number and configuration of sensors can also be made dynamic, essentially providing a set of annotated signals up to a maximum determined by the network architecture, without pre-defined limits on the number and shape of the sensors—approaching the limits of observability of the scene within the allocated memory and compute resources as described above. Spatial imagination and awareness are now available during the training of the task and can be used as a first-class citizen.

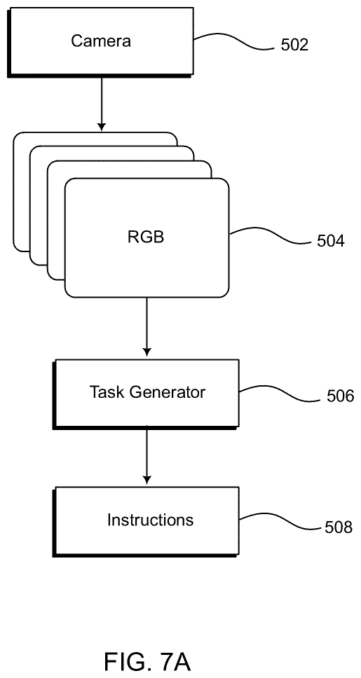

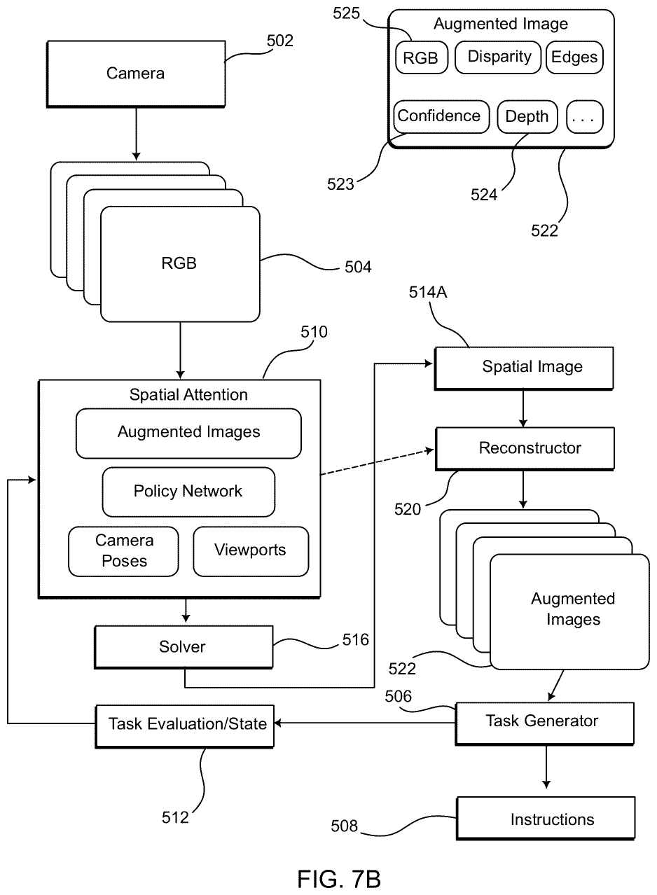

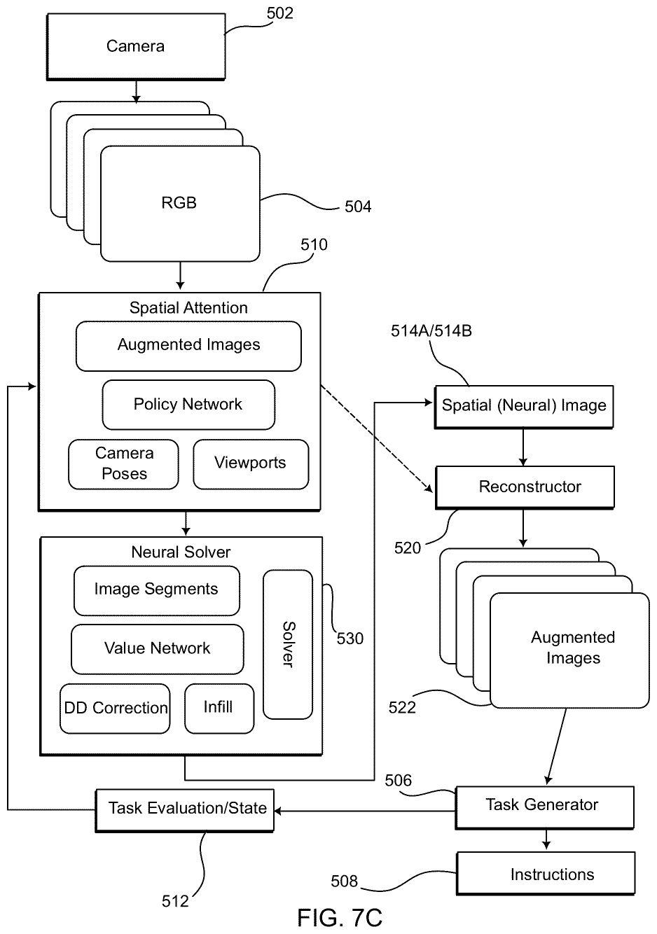

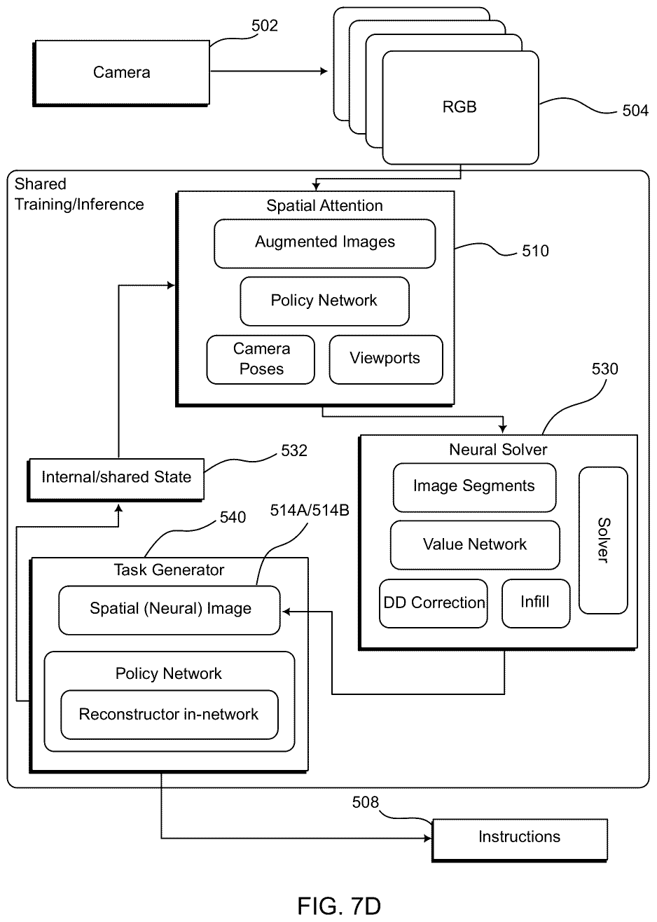

The process of synthesizing virtual sensor(s) may yield additional auxiliary information that can be passed on, along with the primary synthesized signal, for use by downstream tasks. Auxiliary information may for instance include confidence values 523 (see FIG. 7B) indicating the quality of the reconstructed signals, information on which and how source signals were used, additional dimensions or transformations into higher dimension of the output signals that were synthesized along with the primary signal as well as multiple resolutions (up or down sampled), transformations or convolutions of the source signals (for example, edge detection from a Sobel or Laplacian operator) and other products of the source signals used during reconstruction. In a system working with camera sensors for instance, the auxiliary information from a virtual camera may be comprised of a per-pixel depth map 524 and a confidence map 523 indicating the estimated quality of each pixel together with the synthesized image 525 of the virtual camera forming an augmented image 522.

This method benefits from the Neural Solver, In-Network View Generation and Neural Spatial Images.

FIG. 7A shows Task Generator without Spatial Attention. At least one camera 502 provides a set of images 504 to a task generator 506 that results in instructions 508 as shown and described with reference to the system 100 according to FIG. 1.

FIG. 7B shows separately trained task and spatial attention. At least one camera 502 provides a set of images 504 to a spatial attention policy 510 where augmented images through a trained ANN generates virtual camera poses and viewports. A solver 516 is performed on augmented images to provide a spatial image 514A that is reconstructed into synthetic images according to generated camera poses and viewports from spatial attention 510 at reconstructor 520 that provides augmented images 522 to the task generator 506. The solver 516 together with the reconstructor 520 performing the Virtual Sensor Synthesis function with the virtual sensors defined by the camera poses and viewports of 510, the augmented images 522 representing the synthesized signals and the augmented images of 510 derived from the input images 504 representing the input signals. The task evaluation and/or state 512 is a feedback or control loop to influence the spatial attention to revise camera poses and viewports accordingly. Ultimately, task generator 506 results in instructions 508 as shown and described with reference to the system 100 according to FIG. 1.

FIG. 7C shows separately trained task and spatial attention with advanced Neural Solver. At least one camera 502 provides a set of images 504 to a spatial attention policy 510 where augmented images through a trained ANN generates virtual camera poses and viewports. A neural solver 530 is performed on augmented images, generated camera poses and viewports from the spatial attention 510 using advanced techniques further described below such as image segments, disparity data correction and infill to refine a correspondence solver to provide a spatial image or spatial neural image 514B that is reconstructed into synthetic images according to generated camera poses and viewports from 510 at reconstructor 520 that provides augmented images 522 to the task generator 506. The neural solver 530 and reconstructor 520 together performing Virtual Sensor Synthesis with the virtual sensors defined by the camera poses and viewports, the augmented images 522 representing the synthesized signals and the augmented images of 510 derived from the input images 504 representing the input signals. The task evaluation and/or state 512 is a feedback or control loop to influence the spatial attention to revise camera poses and viewports accordingly. Ultimately, task generator 506 results in instructions 508 as shown and described with reference to the system 100 according to FIG. 1.

FIG. 7D shows fully integrated task and attention policy with Neural Solver. At least one camera 502 provides a set of images 504 to a spatial attention policy 510 where augmented images through a trained ANN generates virtual camera poses and viewports. A neural solver 530 is performed on augmented images from the spatial attention 510 using further advanced techniques further described below such as image segments, disparity data correction and infill to refine a correspondence solver to provide a spatial neural image 514B that is reconstructed into synthetic images according to generated camera poses and viewports from spatial attention 510 as part of task generator 540. The neural solver 530 and in-network reconstructor of 540 together performing Virtual Sensor Synthesis with the virtual sensors defined by the camera poses and viewports of 510, the output of in-network reconstruction representing the synthesized signals and the augmented images of 510 derived from the input images 504 representing the input signals. Task generator 540 begins fully aware of virtual sensor synthesis in this configuration directly integrates the concept and may use in-network view generation.

Task generator 540 contains a trained ANN to generate a task or set of tasks. The internal/shared state 532 is a feedback or control loop to influence the spatial attention to revise virtual camera definitions as necessary. The fully integrated task and attention policy with Neural Solver of FIG. 7D effectively integrates the synthesized virtual sensor data within the task generator 540 so that when in the encoded higher-dimensional format of the Neural Image, the elements are part of the networks structure for significantly improved performance and efficiency. Ultimately, task generator 540 results in instructions 508 as shown and described with reference to the system 100 according to FIG. 1.

### Spatial Attention Policy

A Spatial Attention Policy is a method for generating a set, in the best possible implementation the optimal set, of spatial parameters, for one or more sensors such that the next step or steps for a given task can be executed within, and interacting with, a real or virtual scene given the current state of the scene and/or information provided by the task. The Spatial Attention Policy dynamically configures virtual sensors in real time according to the current needs of the task to yield augmented task-relevant information as observed from all relevant vantage points while suppressing distracting task-irrelevant information. A common case is working in three-dimensional space, but a scene could obviously be generalized to a collection of manifolds of diverse topologies and dimensions of up to N in an N-dimensional space. Sensors may include optical sensors like cameras sensitive to various spectra, microphones, CT scanners, haptic sensors and other sensors that can be placed in such a space and observe the same.

Sensor parameters may include position, orientation, resolution, sampling rate, focus and other parameters. Given the set of parameters:
a. A real scene can be observed using a set of real sensors configured according to these parameters. The sensors may be controlled manually or automatically to adopt the required parameters;
b. A virtual scene can be observed using a set of virtual sensors configured according to these parameters; and
c. A real or virtual scene can be observed using a set of virtual sensors configured according to these parameters using a method that can synthesize their signals from those of a separate set of sensors in the same scene be they real or virtual. The task of deriving the signal of the virtual sensors using such a method may itself be supported by a Spatial Attention Policy to configure the input sensor set.

Each variation has use cases: The placement of physical sensors on a sensing module for observing a real-world scene can be optimized using a real scene as described above. The module is designed and manufactured according to the spatial parameters given by the Spatial Attention Policy and then calibrated to evaluate the actual parameters achieved within the tolerances of production for the module. For training purposes, the use of a virtual scene as described above is particularly relevant. A virtual scene can be generated automatically or as a digital twin of the real-world application.

Without constrains of real-time and real space, and with the ability to produce any number of perfect copies or procedural variations, training can be done faster and cheaper. Finally for the transfer to real-world application the third option of a real or virtual scene described above is applicable. The ability to generate complex task specific virtual sensor sets for real-world scenes is a key aspect of this method. Recordings of real-world scenes can be used at scale with nearly arbitrary sensor parameters and the training and real-world execution of tasks has identical capabilities.

The current state of the scene is as observed by the sensors configured according to the previously generated set of parameters by the same policy, or initially a set of parameters provided by a separate Spatial Attention Policy designed to facilitate the task of initializing or delegating tasks to the former, the task alone or the task and default parameters. This implies that a hierarchy of Spatial Attention Policies can be used with a hierarchy of tasks.

Sensor signals are passed to the task for use by the task in any manner desired.

The task may request the Spatial Attention Policy to update the set of parameters at any time by providing its latest information to the policy. This information may include latent or activation information from an ANN driving it and/or information from other related policies.

The Spatial Attention policy may be implemented using heuristics, known functions that enable the parameters to be analytically or numerically derived from the policy input or using an ANN trained to approximate the functions. The latter is most applicable to complex tasks.

Furthermore, a virtual scene resembling the intended real scene, some degree of digital twin, may be used as a development, training, testing and verification environment for the Spatial Attention Policy. Additionally, a Spatial Attention Policy may be transferred from a virtual scene to a real scene.

In-Network View Generation: Signals from a virtual sensor are generated in the form of an ANN layer that takes sensor parameters and a Spatial Image, Spatial Video, Neural Spatial Image or Neural Spatial Video as input and provides one or more images or Neural Images as output. The sensor parameter input and output of the layer look just like those of a normal network layer, but the function represented is effectively more complex than a single network layer. The result is much like a generative/diffusion sub-network but producing output based on scene-specific ground truth.

Solver Reconstructor: A method for generating a Spatial Image (‘solving’) from one or more native views of a scene such that a set of arbitrary views of the same scene can be synthesized (reconstructed) within certain limits resulting from the positions and perspectives of the native views. Together a solver and reconstructor form a method to synthesizing virtual sensor views from a separate set of input sensors views. The Spatial Image, or as a time series a Spatial Video, generated by the solver contains all the information necessary to perform view synthesis (reconstruction) independent of the solver. The Spatial Image or Spatial Video representation can thus be stored, transmitted, and retrieved to perform the reconstruction independent of the time when or the system where the representation was generated. The stored representation retrieved for later use is thus referred to as an intermediate representation. This also means that the solver does not need to know the target views at the time the intermediate representation in the form of a Spatial Image or Spatial Video is generated and any number of views can be synthesized later. Components of one possible implementation of a solver are described in U.S. Pat. Nos. 10,551,913, 11,106,275, 11,960,639 all entitled Virtual 3D Methods, Systems and Software and 11,550,387 entitled Stereo Correspondence Search. Additionally, U.S. Pat. No. 11,238,564 entitled Temporal De-Noising and U.S. Pat. No. 11,501,406 entitled Disparity Cache describe optional components that increase the quality of a Spatial Image or Spatial Video produced by such a solver implementation for some scenes. The entire contents of the aforementioned U.S. Pat. Nos. 10,551,913,11,106,275, 11,960,639, 11,550,387, 11,501,406, and 11,238,564 are herein incorporated by reference. The temporal de-noising method of the prior art referenced above, though similar in name, is distinct and independent from the de-noising method of the present invention in that, for example, U.S. Pat. No. 11,238,564 is concerned with the input images to a solver and the de-noising method of the present invention is concerned with the generation of output by a reconstructor.

One possible implementation of such a view synthesize method for camera sensors is to use a multi-axis stereo-search over the input images to establish a disparity map for each image (‘solving’ the scene) then using the disparity information along with the source images to reconstruct a novel view of the same scene. Examples include those described in U.S. Pat. No. 11,189,043 entitled Image Reconstruction for Virtual 3D, the contents of which is incorporated herein by reference.

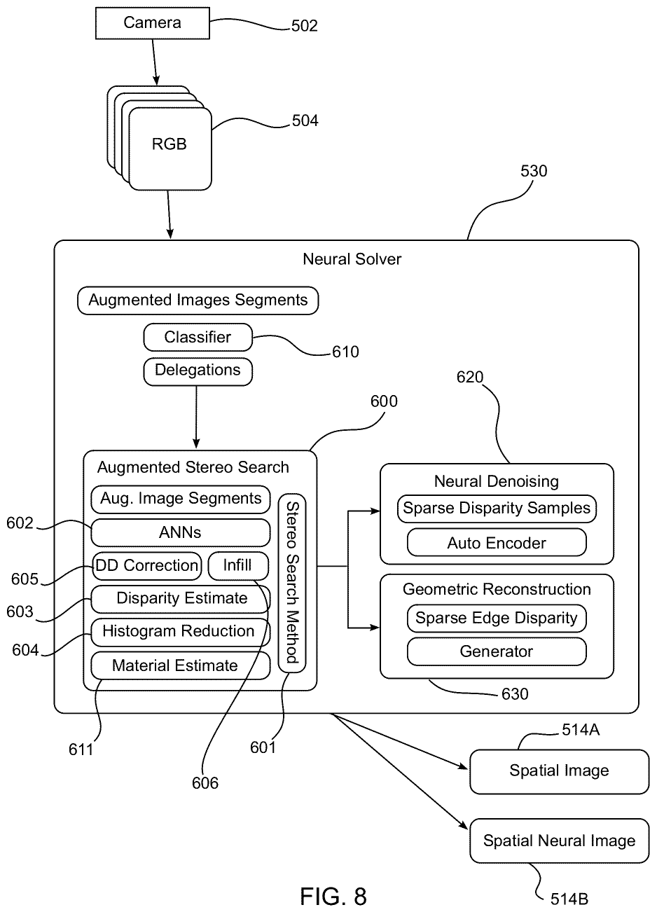

FIG. 8 depicts an illustrative example of the Neural Solver 530. Methods for generating a spatial image 514A or spatial neural image 514B from one or more native views of a scene such that a set of arbitrary views of the same scene can be synthesized (reconstructed) within certain limits derived from the positions and perspectives of the native views. At least one camera 502 provides images 504 representative of the native views of the scene. The images 504 are segmented and augmented as a pre-processing step for all further evaluation of the images. Augmentation includes convolutions and transforms such as color conversion, edge detection and distortion correction. In the Neural Solver 530 a sophisticated disparity-based stereo-search method 601, as discussed above, is augmented with multiple trained ANNs 602 to guide the search depth (in the image level set hierarchy) and breath (along the stereo axis) better than hard-coded heuristics and metrics can, optimally adaptive to a specific scene or content.

The disparity estimation policy 603, having been trained to derive estimated distance information from the content of individual images, is used to establish bounds on the stereo search within augmented image segments by using the stereo correspondence search configuration to convert distances into disparities compatible with the search. This is in particularly interesting to limit the closest distance considered in the correspondence search. The estimation can be performed on lower resolution images to balance the cost of estimation with the benefits of cost reduction in the stereo search. A search for stereo correspondence along epipolar lines is a probabilistic approach and requires an exhaustive search in the general case. The search domain can however be reduced by, for instance, the method described in U.S. Pat. No. 11,550,387 entitled Stereo Correspondence Search. By first estimating disparity and disparity bounds using a content adaptive approach in the form of a trained ANN for disparity estimation 603, the established bounds are translated into limits useable by the above referenced method. The probabilistic approach of an ANN is fitting right in with the probabilistic nature of the underlying search method. Training set data for this approach is produced by exploiting the ability to produce nearly infinite arbitrary samples from known good input images of data using essentially the same method described here but without including the generation of disparity estimates using the ANN. The distance information of the samples is generated by the view-synthesis in that case. Ground-truth distance can also be incorporated when it has been acquired by a sensor, such as a time-of-flight or structured-light sensor, or by a rendering method from a virtual scene. Image-based heuristics are another source of distance estimates, for instance in combination with known illumination patters of the scene.

In the Augmented Stereo Search 600 disparity histograms are reduced by a trained ANN 604 to identify the correct disparity independent of precision/resolution trade-offs 605 that otherwise exist. When performing a stereo correspondence search on the pixel level, a high-quality probability estimate at each step requires comparing a region around the search location. Intuitively, many more false positive matches of high probability will be found for, at the extreme, a single pixel compare kernel than for a larger kernel which is more specific. On the other hand, by increasing the kernel size too much, partially occluded matches can no longer be reliably identified. This leads to issues around discontinuities in the true disparity of the pixel neighborhood. By using an ANN trained to identify such areas based on the content and adjusting the kernel size or a kernel filter mask according to the circumstances the disparity estimate can be both content specific and content sensitive. U.S. Pat. No. 11,501,406 entitled Disparity Cache describes a method that uses motion in the scene over time to reduce the issue for certain cases but is less general, requires multiple steps over time and cannot handle discontinuities where the occluded part of the scene has never been seen or since been evicted from the cache. Training set data is produced by exploiting the ability of produce essentially infinite arbitrary views of different configurations with known good segments of data.

A classifier network 610 is used to improve handling of multi-modal histogram cases of complex materials is employed. This enables better first-layer detection in complex reflective or semi-transparent materials 611 as well as surface type estimation.

Areas of low certainty, such as those without native sensor coverage, are identified by the classifier 610 and delegated to a trained generative network 606 which can hallucinate content based on the scene to fill those areas. This can cover small areas of no-coverage in the source images to produce a complete image. This is mostly relevant for applications where final images are presented to the human eyes. For machine learning application certainty values is inserted as augmented image data in the ANN.

Areas that are not (or only with low confidence) solvable by disparity-search, and which are better solved by different methods or in combination with different methods are identified by the classifier 610 and delegated to specialized methods in the augmented stereo search 600. One such method is to use Neural De-noising 620, for instance based on the auto-encoder architecture using adversarial loss, to reconstruct a dense solution based on sparse but high-confidence samples from the underlying stereo method. The auxiliary information derived by the underlying method and present in the augmented image segments is made available to the de-noising process to aid in the reconstruction of details.

Another classification 610 is for segments that are overexposed, underexposed or without contrast for other reasons. These areas are better delegated to a method constructing geometry 630 bounded on high-confidence values to produce a dense solution in order to reconstruct the relevant area.

When multiple stereo-search axes are available based on the underlying disparity-based method the values across all axes are encoded for the ANNs described above.

Calibration healing for a camera module 370: A value network is trained to detect and repair small deviations in sensor calibration from the initial calibration data that may occur in practical applications due to material expansion, wear and other factors.

Spatial Image, Neural Image, Neural Spatial Image: A Spatial Image is a combination of a i) series of N-dimensional images (pixels, voxels, or other common form of storing N-dimensional pixels) ii) sensor parameters used to produce those images such as affine transform of the sensor, focal length and resolution iii) derived auxiliary data required to synthesize arbitrary (within certain limits) views from those images. Essentially all information required to be able to synthesize novel views of the scene.

A Spatial Video by extension is a time series of Spatial Images. Redundancy within the images and across time is exploited when compressing such a video. Accordingly, the Spatial Video is storage-efficient, yet can be managed like traditional video files.

In a Neural Image, as opposed to a conventional image that stores signals in implicit order and reduced/orthogonal dimensional encoding, the sensor samples are individually or in smaller sets transformed into a higher-dimensional form where the position of the samples in the signals are encoded along with the transformed samples. This allows for sparse representation of area sensors while providing an encoding to a downstream component such as an ANN that is already pre-transformed for ingestion.

In a Spatial Neural Image, instead of providing several sensor signals and their associated auxiliary data in implicit order and original encoding like with a Spatial Image, the Spatial Neural Image method is used to store sensor signals. A Spatial Neural Image, like a Spatial Image, is also the input to sensor synthesis (reconstruction), resulting in a derived Spatial Neural Image (if further synthesize is intended downstream) or a set of Neural Images representing each a single synthesized sensor in the same format as the spatial images in the input.

A Spatial Neural Video by extension is a time series of Neural or Spatial Neural Images. Redundancy within the images and across time is exploited when compressing such a video. Additionally, time can become part of the higher-dimensional encoding of the images.

Synthesized images can be provided with a fully aligned, high-resolution and dense distance estimate derived from the Spatial Image or Spatial Video representation of a scene. This dense distance estimate adds a full extra dimension not otherwise available from 2D images. The distance data can be embedded alongside the color data for use with spatial embeddings. While increasing the embedding size, having direct access to a distance layer reduces the overall network resources required to infer the spatial structure of the scene.

This embedding method may also be used when combining image sensors with specialized distance measurement sensors, such as active optical structured light or time of flight sensors to produce augment views.

The dense distance estimate synthesized for virtual sensors from Spatial Images or Spatial Neural Images is used for a spatial positional embedding of synthesized images for consumption by an ANN. This allows the network to operate on spatial information directly, as a spatial transformer for instance, rather than having to infer all spatial information from 2D images alone. Having knowledge of the scene the embedding be scene relative and thus independent of individual vantage points.

The synthesized color images together with their auxiliary dense distance estimates can also be used to generate a point cloud representative of the scene. Together with the vantage point information a point in three-dimensional space is placed on the principal ray associated with a pixel in the image such that the distance between the point and the vantage point is that of the associated distance estimate. Furthermore, a view-dependent color of each point in the point cloud can be derived from multiple synthesized images and encoded as a spherical harmonic. A size associated with each point in the cloud can be derived from the distance to the vantage point and the image view parameters, such that a sphere with the evaluated size if projected onto the image plane according to the image view parameters and the vantage point, would cover the pixel to a chosen percentage. Points in the point cloud can be merged based on their relative proximity or overlap in space.

The point cloud along with precise view parameters can then be further used to initialize a set of gaussian splats to represent the scene that, given that view synthesis is real-time even for high-resolution captures, serve to reduce the optimization time required in radiance field methods like gaussian splatting to produce a high-quality result. This allows more efficient processing of real-world data for machine learning methods based on such gaussian splats and bridges the use of real-world data with gaussian splats generated from image or text description. The latter has applications in the generation of a large variety of virtual worlds for training agents and can now be used more efficiently to generate environments in part described by real-world captures.

After a set of gaussian splats, each gaussian splat having at least a location in space, covariance, opacity, and color, is initialized from the point cloud it can then be further optimized to represent the scene using a differentiable rendering method-that is a rendering method that allows gradients with respect to scene parameters can be computed based on the output of the rendering method relative to synthesized color images and dense distance estimates representing the source of the point cloud the gaussian splats were initialized from. Additional image can be synthesized for vantage points determined by the optimization process on demand to improve coverage, quality, and determine the level of convergence, or accelerate convergence to the desired quality level.

Those skilled in the art will understand that the above described embodiments, practices and examples of the invention can be implemented using known network, computer processor and telecommunications devices, in which the telecommunications devices can include known forms of cellphones, smartphones, and other known forms of mobile devices, tablet computers, desktop and laptop computers, and known forms of digital network components and server/cloud/network/client architectures that enable communications between such devices.

Those skilled in the art will also understand that method aspects of the present invention can be executed in commercially available digital processing systems, such as servers, PCs, laptop computers, tablet computers, cellphones, smartphones and other forms of mobile devices, as well as known forms of digital networks, including architectures comprising server, cloud, network, and client aspects, for communications between such devices.

The terms “computer software,” “computer code product,” and “computer program product” as used herein can encompass any set of computer-readable programs instructions encoded on a non-transitory computer readable medium. A computer readable medium can encompass any form of computer readable element, including, but not limited to, a computer hard disk, computer floppy disk, computer-readable flash drive, computer-readable RAM or ROM element or any other known means of encoding, storing or providing digital information, whether local to or remote from the cellphone, smartphone, tablet computer, PC, laptop, computer-driven television, or other digital processing device or system. Various forms of computer readable elements and media are well known in the computing arts, and their selection is left to the implementer, In addition, those skilled in the art will understand that the invention can be implemented using computer program modules and digital processing hardware elements, including memory units and other data storage units, and including commercially available processing units, memory units, computers, servers, smartphones and other computing and telecommunications devices. The term “modules”, “program modules”, “components”, and the like include computer program instructions, objects, components, data structures, and the like that can be executed to perform selected tasks or achieve selected outcomes. The various modules shown in the drawings and discussed in the description herein refer to computer-based or digital processor-based elements that can be implemented as software, hardware, firmware and/or other suitable components, taken separately or in combination, that provide the functions described herein, and which may be read from computer storage or memory, loaded into the memory of a digital processor or set of digital processors, connected via a bus, a communications network, or other communications pathways, which, taken together, constitute an embodiment of the present invention.

The terms “data storage module”, “data storage element”, “memory element” and the like, as used herein, can refer to any appropriate memory element usable for Storing program instructions, machine readable files, databases, and other data structures. The various digital processing, memory and storage elements described herein can be implemented to operate on a single computing device or system, such as a server or collection of servers, or they can be implemented and inter-operated on various devices across a network, whether in a server-client arrangement, server-cloud-client arrangement, or other configuration in which client devices can communicate with allocated resources, functions or applications programs, or with a server, via a communications network.

It will also be understood that computer program instructions suitable for a practice of the present invention can be written in any of a wide range of computer programming languages, including Java, C++, and the like. It will also be understood that method operations shown in the flowcharts can be executed in different orders, and that not all operations shown need be executed, and that many other combinations of method operations are within the scope of the invention as defined by the attached claims.

Moreover, the functions provided by the modules and elements shown in the drawings and described in the foregoing description can be combined or sub-divided in various ways, and still be within the scope of the invention as defined by the attached claims.

### Glossary

ANN Artificial Neural Network: An ANN is modelled after the structure and function of biological neural networks in humans and animals. An ANN consists of artificial neurons connected by artificial synapses. Neurons are aggregated into layers where the first layer acts the input layer and the last layer as the output layer. The layers between the first and last layer are referred to as hidden layers.

CNC Computer Numerical Control: Pre-programmed automatic control of machines.

DNN Deep Neural Network: In an ANN the number of hidden layers is the depth of the network. Networks with a depth of two or more are referred to as deep networks while those with only a single hidden layer are called shallow networks.

SSI Synthetic Spatial Imagination: Trained visuospatial skills in an ANN.

While the foregoing description and the accompanying drawing figures provide details that will enable those skilled in the art to practice aspects of the invention, it should be recognized that the description is illustrative in nature and that many modifications and variations thereof will be apparent to those skilled in the art having the benefit of these teachings. It is accordingly intended that the invention herein be defined solely by any claims that may be appended hereto and that the invention be interpreted broadly prior art.

1. A method of generating instructions for automated performance of a task, the method comprising:
continuously acquiring signals representative of observations of at least a portion of one of one or more scenes corresponding to the task;
generating a first set of instructions associated with the task while evaluating the acquired signals;
using the evaluation to identify a target vantage point of any one of the one or more scenes corresponding to the task;
generating signals representative of observations corresponding to the target vantage point; and
generating a second set of instructions associated with the task while evaluating the signals representative of observations corresponding to the target vantage point, the first set of instructions and the second set of instructions representative of the automated performance of the task.

2.-26. (canceled)

27. The method according to claim 1, wherein the one or more scenes corresponding to the task comprises at least two scenes and a coordinate system transform is applied to convert between a pose in each of the at least two scenes.

28. The method according to claim 27, wherein one of the at least two scenes represents at least one of a proxy, a surrogate, an extension and an approximation of at least part of another scene of the at least two scenes.

29.-34. (canceled)

35. The method according to claim 1, wherein the generated signals representative of observations comprise image data.

36. The method according to claim 35, wherein the image data is generated by a rendering method from a virtual scene representation.

37. The method according to claim 35, wherein the image data comprises a plurality of resolutions.

38. The method according to claim 35, wherein the image data further comprises a depth map and a confidence map indicating a quality of each pixel of the image data and/or depth map.

39. The method according to claim 35, wherein the step of generating signals representative of observations corresponding to the target vantage point comprises reconstructing a synthetic image using one or more source images from a different perspective.

40.-56. (canceled)

57. The method according to claim 35, wherein the step of generating signals representative of observations corresponding to the target vantage point comprises selecting an image from one of a dynamic set of virtual sensors, each of which provide generated images representative of observations corresponding to a different vantage point.

58.-76. (canceled)

77. A method of generating instructions for automated performance of a task, the method comprising:
continuously acquiring signals representative of observations of at least a portion of any one of one or more scenes corresponding to the task;
generating a first set of instructions associated with the task while evaluating the acquired signals;
generating and storing an intermediate representation from which signals representative of observations corresponding to a different vantage point of any one of the one or more scenes can be derived;
using the evaluation to identify a target vantage point corresponding to the task;
generating signals representative of observations corresponding to the target vantage point using the stored intermediate representation;
generating a second instruction associated with the task using the signals representative of observations corresponding to the target vantage point; and
performing the task responsive to the first instruction and the second instruction.

78. The method according to claim 77, wherein the step of generating signals representative of observations corresponding to the target vantage point using the stored intermediate representation comprises at least one of a reconstructed signal.

79. The method according to claim 78, wherein generating an intermediate representation includes processing a signal derived from a sensor providing a signal from which at least a portion of the signal representative of an observation corresponding to the target vantage point can be synthesized.

80. The method according to claim 79, wherein the signals representative of observations comprise image data.

81. The method according to claim 80, wherein the intermediate representation includes at least one of a spatial image and a neural image.

82. The method according to claim 80, wherein the intermediate representation includes a time sequence comprising at least one of a spatial video and a spatial neural video.

83. The method according to claim 77, wherein the stored intermediate representation from which signals representative of observations corresponding to the target vantage point can be synthesized includes at least one of a spatial image and a spatial neural image.

84. The method according to claim 77, wherein the stored representation of signals from which signals representative of observations corresponding to the target vantage point include a time sequence comprising at least one of a spatial video and a spatial neural video.

85.-118. (canceled)

119. A method of generating instructions for automated performance of a task, the method comprising:
continuously acquiring signals representative of observations of at least a portion of one of one or more scenes corresponding to the task;
generating a first set of instructions associated with the task while evaluating the acquired signals;
using the evaluation to identify a target vantage point of any one of the one or more scenes corresponding to the task;
generating signals representative of observations corresponding to the target vantage point, the generated signals representative of observations corresponding to the target vantage point comprising at least one of a reconstructed signal; and
generating a second set of instructions associated with the task while evaluating the signals representative of observations corresponding to the target vantage point, the first set of instructions and the second set of instructions representative of the automated performance of the task.

120. The method according to claim 119, wherein the reconstructed signal comprises generating an intermediate representation of a signal derived from a sensor providing a signal from which at least a portion of the signals representative of observations corresponding to the targeted vantage point can be synthesized.

121. The method according to claim 120, wherein the intermediate representation of a signal is stored for retrieval to generate signals representative of observations corresponding to the target vantage point.

122. The method according to claim 121, wherein a plurality of signals representative of observations corresponding to one or more additional target vantage points are generated and the step of generating a second set of instructions associated with the task determines which of the plurality of signals representative of observations is preferred.

123. The method according to claim 119, wherein signals representative of observations corresponding to the target vantage point are generated from the intermediate representation.

124. The method according to claim 123, wherein the step of evaluating the signals representative of observations corresponding to the target vantage point includes evaluating the intermediate representation.
